(19) United States
(12) Patent Application Publication
(10) Pub. No.: US 2024/0066710 A1
(43) Pub. Date: Feb. 29, 2024

(54) TECHNIQUES FOR CONTROLLING ROBOTS WITHIN ENVIRONMENTS MODELED BASED ON IMAGES

(71) Applicant: NVIDIA CORPORATION, Santa Clara, CA (US)

(72) Inventors: Balakumar SUNDARALINGAM, Seattle, WA (US); Stanley BIRCHFIELD, Sammamish, WA (US); Zhenggang TANG, Redmond, WA (US); Jonathan TREMBLAY, Redmond, WA (US); Stephen TYREE, University City, MO (US); Bowen WEN, Bellevue, WA (US); Ye YUAN, State College, PA (US); Charles LOOP, Mercer Island, WA (US)

(21) Appl. No.: 18/168,482

(22) Filed: Feb. 13, 2023

Related U.S. Application Data
(60) Provisional application No. 63/373,846, filed on Aug. 29, 2022.

(51) Int. Cl. B25J 9/16; B25J 19/02

(52) U.S. Cl. CPC B25J 9/1697; B25J 9/163; B25J 9/1664; B25J 9/1676; B25J 19/023

(57) ABSTRACT

One embodiment of a method for controlling a robot includes generating a representation of spatial occupancy within an environment based on a plurality of red, green, blue (RGB) images of the environment, determining one or more actions for the robot based on the representation of spatial occupancy and a goal, and causing the robot to perform at least a portion of a movement based on the one or more actions.

### CROSS-REFERENCE TO RELATED APPLICATIONS

This application claims priority benefit of the United States Provisional Patent Application titled, “TECHNIQUES FOR MANIPULATOR COLLISION AVOIDANCE BASED ON RGB-MODELED ENVIRONMENTS,” filed on Aug. 29, 2022, and having Ser. No. 63/373,846. The subject matter of this related application is hereby incorporated herein by reference.

### BACKGROUND

### Technical Field

Embodiments of the present disclosure relate generally to computer science and robotics and, more specifically, to techniques for controlling robots within environments modeled based on images.

### Description of the Related Art

Robots are being increasingly used to perform automated tasks in various environments. One conventional approach for controlling a robot within an environment involves creating a virtual three-dimensional (3D) reconstruction of the environment using depth data acquired for the environment, or depth data in conjunction with other types of data, such as RGB (red, green, blue) image data. The depth data can be acquired via one or more depth sensors, such as a depth camera. Once created, the 3D reconstruction of the environment is used to control the robot such that the robot is caused to make movements that avoid obstacles within the environment. This type of robot control, which can be rapid enough to dynamically respond to changes within the environment in real time, is sometimes referred to as “reactive control.”

One drawback of the above approach for reactive control is that depth data for the environment in which the robot operates may not be available. Further, even in cases where depth data for the environment is available, the depth data can be inaccurate and/or have relatively low resolution. For example, conventional depth cameras are oftentimes unable to acquire accurate depths of transparent surfaces, reflective surfaces, dark surfaces, and occlusions, among other things. In addition, conventional depth cameras typically have lower resolution than RGB cameras. Consequently, complex geometries and fine details may not be fully captured within the depth data acquired by such depth cameras. As a general matter, depth data that is inaccurate and/or low-resolution cannot be used to create accurate 3D reconstructions of the environments in which robots operate, thereby undermining the ability to implement reactive control techniques.

As the foregoing illustrates, what is needed in the art are more effective techniques for controlling robots.

### SUMMARY

One embodiment of the present disclosure sets forth a computer-implemented method for controlling a robot. The method includes generating a representation of spatial occupancy within an environment based on a plurality of red, green, blue (RGB) images of the environment. The method further includes determining one or more actions for the robot based on the representation of spatial occupancy and a goal. In addition, the method includes causing the robot to perform at least a portion of a movement based on the one or more actions.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, RGB images, rather than depth data, are used to create a representation of spatial occupancy within an environment used to control a robot. The RGB images can be more accurate, and can have higher resolution, than depth data that is acquired via a depth camera. By using the RGB images, relatively accurate representations of spatial occupancy can be created and used to control robots within various environments. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer-based system configured to implement one or more aspects of the various embodiments;

FIG. 2 is a block diagram of the computing device of FIG. 1, according to various embodiments;

FIG. 3 is a more detailed illustration of the occupancy representation generator and the robot control application of FIG. 1, according to various embodiments;

FIG. 4 illustrates how an exemplar full signed distance function is generated from exemplar images, according to various embodiments;

FIG. 5 illustrates how a robot is controlled to move within an environment based on a representation of occupancy, according to various embodiments;

FIG. 6 illustrates a flow diagram of method steps for controlling a robot to move within an environment, according to various embodiments;

FIG. 7 is a more detailed illustration of the step of generating a representation of spatial occupancy based on RGB images set forth in FIG. 6, according to various embodiments; and

FIG. 8 is a more detailed illustration of the step of determining a robot action based on a goal and a representation of spatial occupancy set forth in FIG. 6, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide improved techniques for controlling a robot within an environment. In some embodiments, a representation of where space is occupied by objects within an environment (“representation of occupancy”) is generated based on images of the environment captured using an RGB (red, green, blue) camera. After the representation of occupancy is generated, a robot control application can control a robot to avoid obstacles within the environment by iteratively: determining a robot action based on a goal and the representation of occupancy, and controlling the robot to move based on the robot action.

The techniques for controlling robots have many real-world applications. For example, those techniques could be used to control a robot to perform an assembly task in a manufacturing environment while avoiding obstacles. As another example, those techniques could be used to control a robot to grasp and move an object while avoiding obstacles. As another example, those techniques could be used to perform machine tending, in which case the geometry of the machine and obstacles are important.

The above examples are not in any way intended to be limiting. As persons skilled in the art will appreciate, as a general matter, the techniques for controlling robots described herein can be implemented in any suitable application.

### System Overview

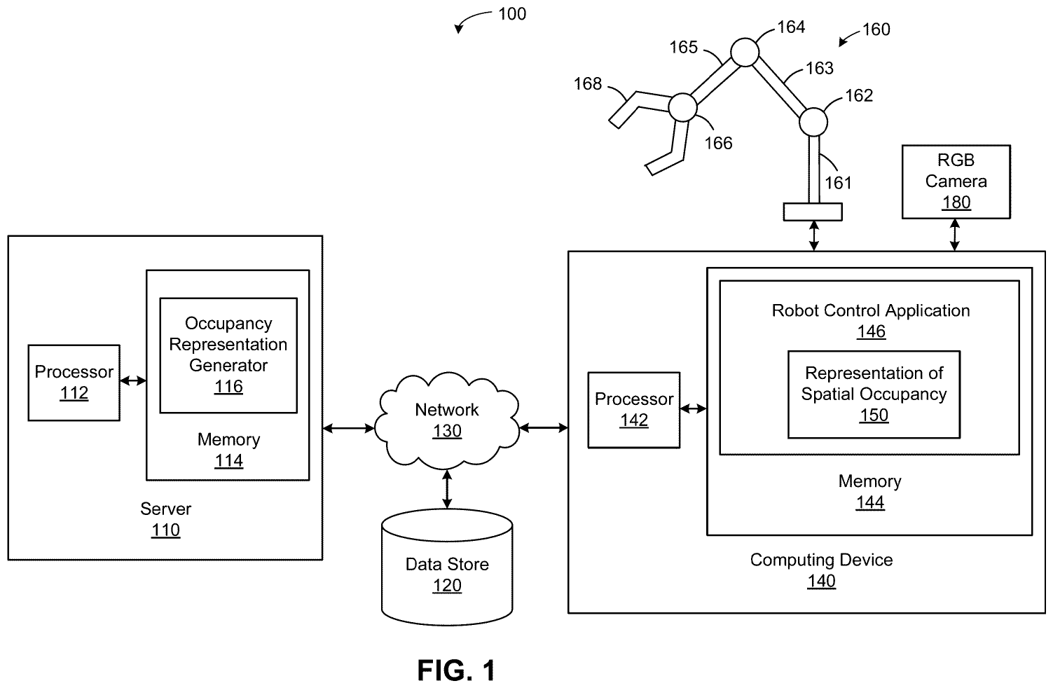

FIG. 1 is a block diagram illustrating a computer-based system 100 configured to implement one or more aspects of the various embodiments. As shown, the system 100 includes a server 110, a data store 120, and a computing device 140 in communication over a network 130, which can be a wide area network (WAN) such as the Internet, a local area network (LAN), or any other suitable network. In addition, the system 100 includes a robot 160 and a RGB (red, green, blue) camera that are in communication with the computing device 140 via, e.g., a network and/or cables.

As shown, an occupancy representation generator 116 executes on a processor 112 of the server 110 and is stored in a system memory 114 of the server 110. The processor 112 receives user input from input devices, such as a keyboard or a mouse. In operation, the processor 112 is the master processor of the server 110, controlling and coordinating operations of other system components. In particular, the processor 112 can issue commands that control the operation of a graphics processing unit (GPU) (not shown) that incorporates circuitry optimized for graphics and video processing, including, for example, video output circuitry. The GPU can deliver pixels to a display device that can be any conventional cathode ray tube, liquid crystal display, light-emitting diode display, or the like.

The system memory 114 of the server 110 stores content, such as software applications and data, for use by the processor 112 and the GPU. The system memory 114 can be any type of memory capable of storing data and software applications, such as a random access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, or any suitable combination of the foregoing.

It will be appreciated that the server 110 shown herein is illustrative and that variations and modifications are possible. For example, the number of processors 112, the number of GPUs, the number of system memories 114, and the number of applications included in the system memory 114 can be modified as desired. Further, the connection topology between the various units in FIG. 1 can be modified as desired. In some embodiments, any combination of the processor 112, the system memory 114, and a GPU can be replaced with any type of virtual computing system, distributed computing system, or cloud computing environment, such as a public, private, or a hybrid cloud.

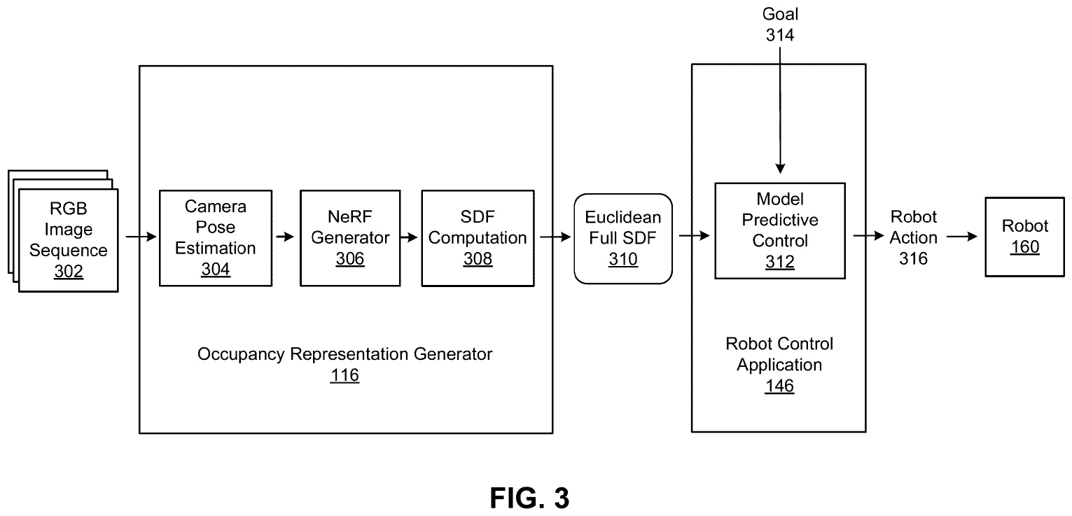

In some embodiments, the occupancy representation generator 116 is configured to receive RGB images and generate, based on the RGB images, a representation of spatial occupancy 150 (also referred to herein as “representation of occupancy” or “occupancy representation”) within an environment. Techniques for generating representations of occupancy are discussed in greater detail below in conjunction with FIGS. 3-4 and 6-7. Generated representations of spatial occupancy can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in some embodiments the server 110 can include the data store 120.

As shown, a robot control application 146 that utilizes the representation of occupancy 150 is stored in a system memory 144, and executes on a processor 142, of the computing device 140. Once generated, a representation of occupancy can be deployed, such as via robot control application 146, for use in controlling a robot to perform tasks while avoiding obstacles in the environment associated with the representation of occupancy, as discussed in greater detail below in conjunction with FIGS. 3, 6, and 8.

As shown, the robot 160 includes multiple links 161, 163, and 165 that are rigid members, as well as joints 162, 164, and 166 that are movable components that can be actuated to cause relative motion between adjacent links. In addition, the robot 160 includes a gripper 168, which is the last link of the robot 160 and can be controlled to grip an object, such as object 170. Although an exemplar robot 160 is shown for illustrative purposes, techniques disclosed herein can be employed to control any suitable robot.

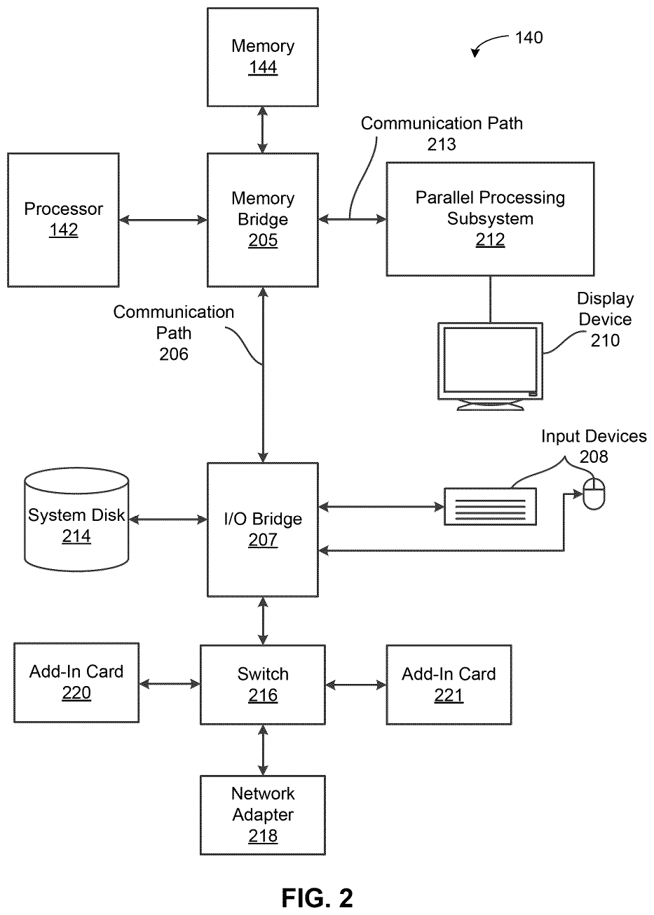

FIG. 2 is a block diagram of the computing device 140 of FIG. 1, according to various embodiments. As persons skilled in the art will appreciate, computing device 140 can be any type of technically feasible computer system, including, without limitation, a server machine, a server platform, a desktop machine, laptop machine, a hand-held/mobile device, or a wearable device. In some embodiments, computing device 140 is a server machine operating in a data center or a cloud computing environment that provides scalable computing resources as a service over a network. In some embodiments, the server 110 can include similar components as the computing device 140.

In various embodiments, the computing device 140 includes, without limitation, the processor 142 and the system memory 144 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard or a mouse, and forward the input information to processor 142 for processing via communication path 206 and memory bridge 205. In some embodiments, computing device 140 may be a server machine in a cloud computing environment. In such embodiments, computing device 140 may not have input devices 208. Instead, computing device 140 may receive equivalent input information by receiving commands in the form of messages transmitted over a network and received via the network adapter 218. In one embodiment, switch 216 is configured to provide connections between I/O bridge 207 and other components of the computing device 140, such as a network adapter 218 and various add-in cards 220 and 221.

In one embodiment, I/O bridge 207 is coupled to a system disk 214 that may be configured to store content and applications and data for use by processor 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, or the like. In such embodiments, the parallel processing subsystem 212 incorporates circuitry optimized for graphics and video processing, including, for example, video output circuitry. Such circuitry may be incorporated across one or more parallel processing units (PPUs), also referred to herein as parallel processors, included within parallel processing subsystem 212. In other embodiments, the parallel processing subsystem 212 incorporates circuitry optimized for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and compute processing operations. System memory 144 includes at least one device driver configured to manage the processing operations of the one or more PPUs within parallel processing subsystem 212. In addition, the system memory 144 includes the robot control application 146. The robot control application 146 can be any technically-feasible application that performs motion planning and controls a robot according to techniques disclosed herein. For example, the robot control application 146 could perform motion planning and control a robot to perform an assembly task in a manufacturing environment while avoiding obstacles. As another example, the robot control application 146 could perform motion planning and control a robot to grasp and move an object while avoiding obstacles. Although described herein primarily with respect to the robot control application 146, techniques disclosed herein can also be implemented, either entirely or in part, in other software and/or hardware, such as in the parallel processing subsystem 212.

In various embodiments, parallel processing subsystem 212 may be integrated with one or more of the other elements of FIG. 2 to form a single system. For example, parallel processing subsystem 212 may be integrated with processor 142 and other connection circuitry on a single chip to form a system on chip (SoC).

In one embodiment, processor 142 is the master processor of computing device 140, controlling and coordinating operations of other system components. In one embodiment, processor 142 issues commands that control the operation of PPUs. In some embodiments, communication path 213 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 202, and the number of parallel processing subsystems 212, may be modified as desired. For example, in some embodiments, system memory 144 could be connected to processor 142 directly rather than through memory bridge 205, and other devices would communicate with system memory 144 via memory bridge 205 and processor 142. In other embodiments, parallel processing subsystem 212 may be connected to I/O bridge 207 or directly to processor 142, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in some embodiments. For example, the parallel processing subsystem 212 could be implemented as a virtual graphics processing unit (GPU) that renders graphics on a virtual machine (VM) executing on a server machine whose GPU and other physical resources are shared across multiple VMs.

### Controlling Robots within Environments Using RGB Images

FIG. 3 is a more detailed illustration of the occupancy representation generator 116 and the robot control application 146 of FIG. 1, according to various embodiments. As shown, the occupancy representation generator 116 includes a camera pose estimation module 304, a neural radiance field (NeRF) generator 306, and a signed distance function (SDF) computation module 308.

In operation, the camera pose estimation module 304 takes an RGB (red, green, blue) image sequence 302 as input. In some embodiments, the image sequence 302 includes frames of a video captured from different viewpoints. In some other embodiments, the image sequence 302 includes standalone images captured from different viewpoints. The camera pose estimation module 304 determines a camera pose from which each image in the RGB image sequence 302 was captured. The camera poses can be determined in any technically feasible manner. In some embodiments, the RGB image sequence 302 can be captured by a camera mounted on a robot that moves through the environment. For example, the camera could be mounted on an end effector (e.g., a wrist or hand) of the robot. In such cases, the camera pose estimation module 304 can use forward kinematics to compute the position of an end effector, and the pose of the mounted camera, based on known joint parameters of the robot. Additionally or alternatively, in some embodiments, the robot can include sensors (e.g., an IMU (inertial measurement unit), LIDAR (light detection and ranging), etc.) that acquire sensor data used to estimate the camera poses at which images are captured. In some embodiments, the camera pose estimation module 304 can apply a structure-from-motion (SfM) or simultaneous localization and mapping (SLAM) technique to the RGB image sequence 302 in order to determine associated camera poses, up to an unknown scale factor. In such cases, the scale can be determined based on a known scale in the environment, such as an object of a known size; a marker, such as a QR code, having a known size; or in any other technically feasible manner. For example, in some embodiments, the COLMAP technique can be applied to determine a camera pose for each image in the RGB image sequence 302. In some embodiments, the camera pose estimation module 304 can receive the camera poses from another source, such as an augmented reality toolkit that is included in some mobile devices and can provide camera poses to the camera pose estimation module 304.

The NeRF generator 306 trains a NeRF model based on the images in the RGB image sequence 302 and the associated camera poses. In some embodiments, the NeRF model is an artificial neural network that is trained to take the coordinates of a point in space and a viewing direction as inputs, and to output an RGB value and a density associated with the point and direction. The density can be considered a probabilistic representation of occupancy. The NeRF model can be generated in any technically feasible manner using the images in the RGB image sequence 302 and the associated camera poses as training data, including via known techniques. For example, the instant NGP (neural graphics primitive), Neural RGBD, DeepSDF, VoISDF (volume rendering of neural implicit surfaces), or traditional NeRF techniques could be used by the NeRF generator 306 to generate the NeRF model.

The SDF computation module 308 generates a Euclidean full SDF 310 (also referred to herein as an “ESDF”) using the NeRF model generated by the NeRF generator 306. The ESDF 310 specifies the distances from points in space of the environment to the surfaces of one or more objects within the environment. From a given point in space, a positive distance indicates that the point is outside an object, and a negative distance indicates that the point is inside an object. The ESDF 310 is defined everywhere in the environment, as opposed to a truncated SDF that would only be defined within a distance threshold of objects within the environment. The ESDF 310 is a representation of spatial occupancy that indicates where space within the environment is occupied by objects, walls, etc. A robot cannot be moved into the occupied regions of space, which are assumed to be static. It should be noted the ESDF 310 is a smoother, more robust, and/or more memory efficient representation of spatial occupancy than some other representations, such as a voxel representation of spatial occupancy that discretizes space into voxels and indicates the occupancy of each voxel. In addition, querying the ESDF 310 to obtain the distance to a closest surface is more computationally efficient relative to querying the NeRF model for such a distance.

In some embodiments, in order to generate the ESDF 130, the SDF computation module 308 first generates a 3D mesh by querying the NeRF model and determining whether various points in space are occupied based on associated densities output by the NeRF model. In such cases, points associated with densities that are greater than a threshold are considered occupied, and the 3D mesh is constructed from such points. For example, in some embodiments, the SDF computation module 308 can perform the Marching Cubes technique to extract a polynomial mesh of an isosurface from a 3D discrete density field obtained by querying the NeRF model on a dense grid of point locations. Smoothing of the densities can also be performed in some embodiments.

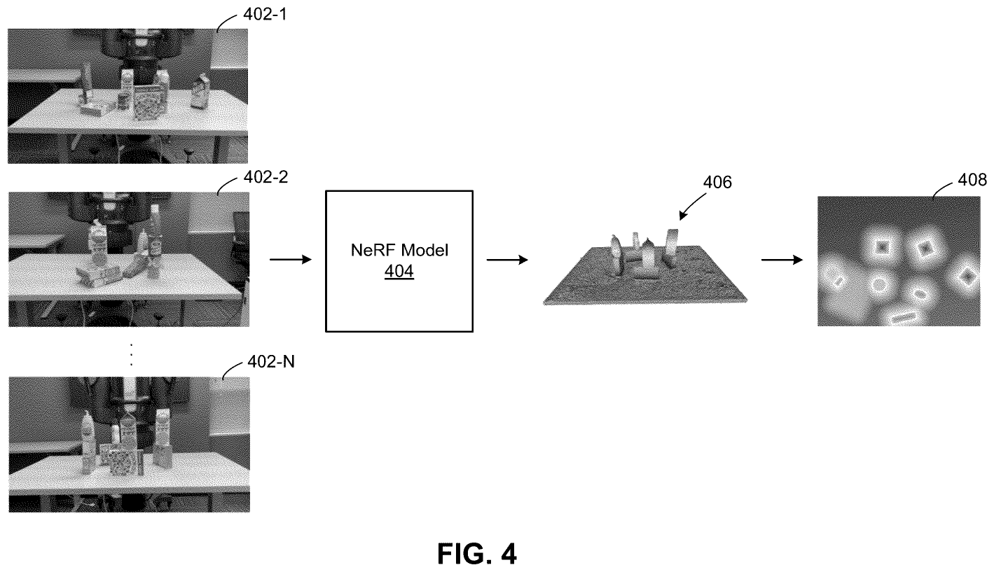

FIG. 4 illustrates how an exemplar ESDF is generated from exemplar RGB images, according to various embodiments. As shown, RGB images 402-1 to 402-N (referred to herein collectively as “RGB images 402” and individually as an “RGB image 402”) of an environment that are captured from different camera poses are used, along with the associated camera poses, to train a NeRF model 404. In turn, the NeRF model 404 is queried to determine the densities at various points in space, and the densities are used to construct a 3D mesh 406 representation of the environment. Illustratively, objects are reconstructed accurately in the 3D mesh 406, unlike some conventional techniques that can struggle to capture fine details or that can generate reconstructions with holes. The 3D mesh 406 is then converted to an ESDF representation of the environment, a 2D horizontal slice 408 of which is shown for illustrative purposes. Because the 3D mesh 406 is relatively accurate and water-tight (i.e., does not include holes), the ESDF can be generated accurately.

More formally, in some embodiments, the neural radiance field of the NeRF model 404 takes as input a query 3D position x∈ [symbol] ³ and a 3D viewing direction d∈ [symbol] ³, ∥d∥=1. The output of the neural radiance field is a RGB value c∈[0,1]³ and the density value σ∈[0, ∞). The neural radiance field can be written as ƒ(x, d) [symbol] (c, σ), where σ indicates the differential likelihood of a ray hitting a particle (i.e., the probability of hitting a particle while traveling an infinitesimal distance). Given multi-view RGB images and associated camera poses, query points are allocated by sampling various traveling times t along the ray r(t)=o_{w}+t·d_{w}, where o_{w} and d_{w} denote camera origin and ray direction in the world frame, respectively. Based on volume rendering, the final color of the ray is then integrated via alpha compositing:

ĉ(r)=∫ₜ_{ₙ}^{t}^{_{ƒ}}T(t)σ(r(t))c(r(t),d)dt, (1)

T(t)=exp(−∫ₜ_{ₙ}^{t}σ(r(s))ds). (2)

In practice, the integral of equation (1) can be approximated by quadrature. In addition, the neural radiance field function ƒ(⋅)=MLP(enc(⋅)) is composed of a multi-scale grid feature encoder enc and a multilayer perceptron (MLP). ƒ can be optimized per-scene by minimizing the L₂ loss between volume rendering and the corresponding pixel value obtained from RGB images, i.e., by minimizing

[symbol]

=Σ_{r∈R}∥c̅(r)−ĉ(r)∥₂.

In equation (3), ĉ is the predicted integral RGB value along the ray, c̅ is the true observation from the RGB image at the pixel location through which the ray r travels, and R is the total ray set for training. Once the NeRF model 404 is trained, density values can be queried on a dense grid of point locations. The Marching Cubes technique can then be used to extract a polynomial mesh of an isosurface from the 3D discrete density field σ, with the isovalue being set to, e.g., 2.5 for solid surfaces.

Although described herein with respect to generating a NeRF model, a 3D mesh from the NeRF model, and an ESDF from the 3D mesh as a reference example, in some embodiments, a representation of spatial occupancy within an environment can be generated in any technically feasible manner. For example, in some embodiments, the environment can be reconstructed in 3D via a NeRF model, the reconstruction can be projected onto virtual depth cameras that generate virtual depth images, and the RGB images and virtual depth images can then be used (e.g., via the iSDF technique) to construct an ESDF. As another example, a truncated SDF can be generated from RGB images using iSDF or a similar technique, and the truncated SDF can be converted to a 3D mesh and then to an ESDF. As further examples, in some embodiments, a voxel (or other primitive-based) representation of occupancy, a point cloud, or a representation of closest points of objects, can be used as the representation of spatial occupancy and generated using known techniques. For example, the VoxBlox technique could be applied to generate a voxel representation of occupancy that discretizes space into voxels and indicates the occupancy of each voxel. As yet another example, in some embodiments, an ESDF can be computed using VoxBlox or a similar technique, after which a neural network (e.g., a multi-layer perceptron) can be trained to mimic the ESDF function based on training data generated using the ESDF. In such cases, querying the neural network can potentially be faster and use less memory than querying the ESDF function itself.

Returning to FIG. 3, the robot control application 146 performs motion planning and controls the robot 160 according to planned motions. As shown, the robot control application 146 includes a model predictive control module 312 that takes as input (1) the ESDF 310 output by the occupancy representation generator, and (2) a goal to be achieved by the robot 160. Any suitable goal can be used in some embodiments, and the goal will generally depend on the task being performed by the robot 160. In operation, the robot control application 146 determines, over a number of iterations, successive actions of the robot 160 that move the robot 160 to reach the goal. Any technically feasible actions, such as joint-space accelerations, can be determined in some embodiments. In some embodiments, the robot control application 146 iteratively: (1) determines a robot action 316 based on the goal and the ESDF 130, and (2) controls the robot to move according to the robot action 316. In such cases, to determine the robot action 316, the robot control application 146 (1) samples multiple robot trajectories; (2) computes costs associated with each sampled trajectory, with the cost function being evaluated in part based on whether the robot collides with any occupied regions of space, as indicated by the representation of occupancy; and (3) determines a robot action based on a trajectory associated with the lowest cost. Accordingly, the robot control application 146 can perform reactive control, in which the robot is controlled to make movements that avoid obstacles within the environment.

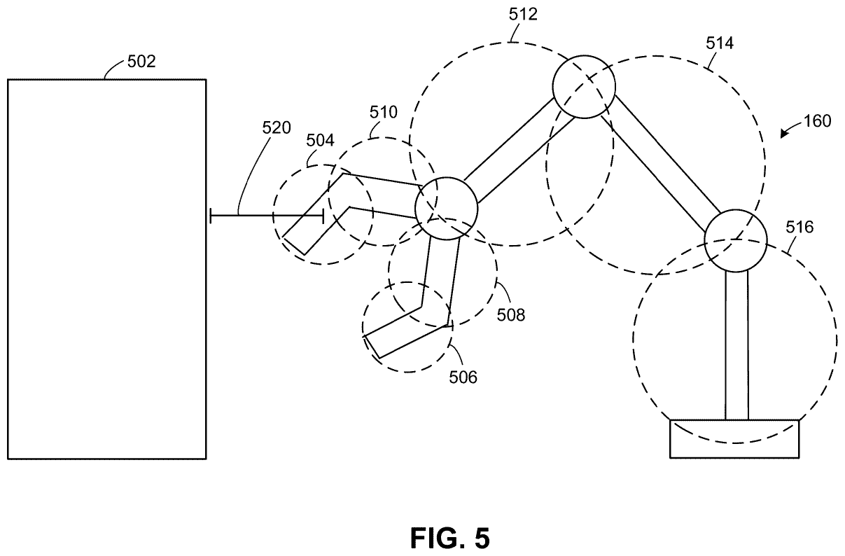

FIG. 5 illustrates how the robot 160 is controlled to move within an environment based on a representation of occupancy, according to various embodiments. As described, in some embodiments, the robot control application 146 iteratively samples multiple robot trajectories, computes costs associated with each sampled trajectory, determines a robot action based on a trajectory associated with the lowest cost, and controls the robot 160 to perform the robot action. In some embodiments, each sampled trajectory includes a randomly generated sequence of joint-space accelerations, or any other technically feasible actions, of the robot 160 that extends a fixed number of time steps into the future.

As shown, a cost function that is used to compute the cost associated with each sampled trajectory includes a term that penalizes collisions of the robot 160 with objects in the environment when the robot 160 moves according to the sampled trajectory. Such collisions can occur when the distance between the centers of any bounding sphere of a link of the robot 160 and an object within the environment is less than a radius of the bounding sphere. Although one bounding sphere 504, 506, 508, 510, 512, 514, and 516 per link is shown for illustrative purposes, in some embodiments, each link of a robot can be associated with more than one bounding sphere, which can provide a better approximation of the robot geometry than one bounding sphere per link. The distance between the center of a bounding sphere 504, 506, 508, 510, 512, 514, or 516 and an object can be determined by querying the ESDF function, which as described gives the distance to the surface of an object for different points in space. Although described herein primarily with respect to bounding spheres as a reference example, bounding cuboids or other bounding geometries that occupy the robot space can be used in lieu of bounding spheres in some embodiments. However, in such cases, collision detection can require multiple queries of the ESDF function, as opposed to a single query for bounding spheres.

Illustratively, when the robot 160 is in a particular pose during a sampled trajectory, the distance 520 from the center of the bounding sphere 504 to an object 502 in the environment, determined using an ESDF, is greater than a radius of the bounding sphere 504, meaning that no collision occurs. A similar computation can be performed for the other bounding spheres 506, 508, 510, 512, 514, and 516 to determine whether associated links of the robot 160 collide with objects in the environment. As described, a cost function that, among other things, penalizes collisions of the robot 160 with objects in the environment can be used to identify a sampled trajectory that is associated with a lowest cost, and the robot 160 can then be controlled to perform an action based on the sampled trajectory associated with the lowest cost. In some embodiments, the cost function includes a term that penalizes collisions of the robot 160 with objects in the environment. The cost function can also include any other technically feasible term(s) in some embodiments. For example, in some embodiments, the cost function can also include a term that penalizes self collisions by testing for whether any bounding spheres collide with other bounding spheres. As another example, in some embodiments, the cost function can also include a term that helps maintain a constant distance between the robot 160 and another object, such as the surface of a wall, window, or table.

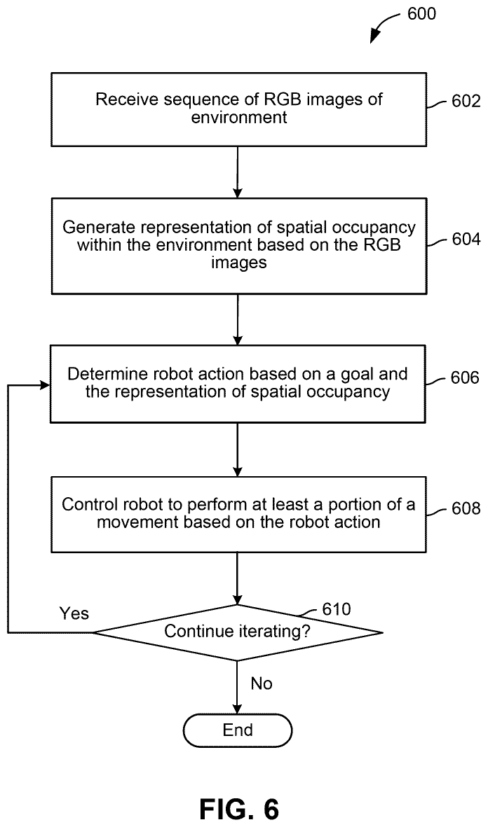

FIG. 6 illustrates a flow diagram of method steps for controlling a robot to move within an environment, according to various embodiments. Although the method steps are described in conjunction with the systems of FIGS. 1-3, persons skilled in the art will understand that any system configured to perform the method steps in any order falls within the scope of the present embodiments.

As shown, a method 600 begins at step 602, where the occupancy representation regenerator 116 receives a sequence of RGB images of an environment. The RGB images can be captured in any technically feasible manner in some embodiments. For example, in some embodiments, the RGB images are captured by an RGB camera mounted on a robot that moves through a portion of the environment. As another example, in some embodiments, the RGB images are captured by manually moving a camera through a portion of the environment.

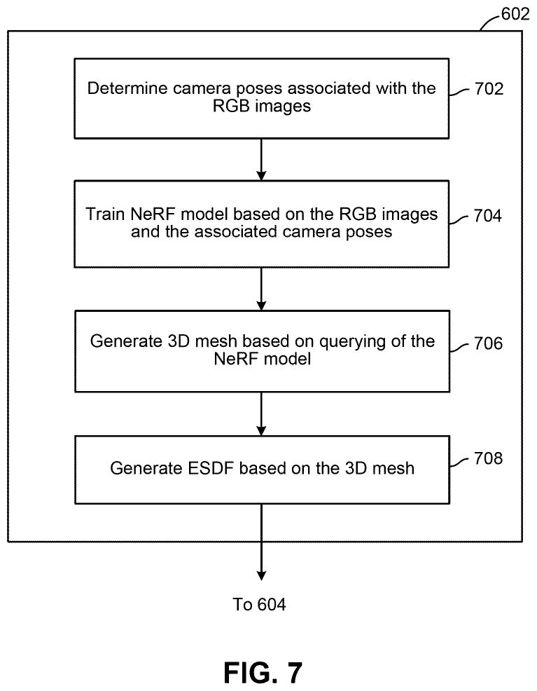

At step 604, the occupancy representation regenerator 116 generates a representation of spatial occupancy within the environment based on the RGB images. In some embodiments, the occupancy representation regenerator 116 generates the representation of spatial occupancy by determining camera poses associated with the RGB images, training a NeRF model based on the RGB images and camera poses, generating a 3D mesh based on querying of the NeRF model, and generating an ESDF based on the 3D mesh, as described in greater detail below in conjunction with FIG. 7. In some other embodiments, the occupancy representation regenerator 116 can generate any suitable representation of spatial occupancy in any technically feasible manner. For example, in some embodiments, a model representing a truncated SDF, a voxel representation of occupancy, or a point cloud can be generated as the representation of spatial occupancy using known techniques.

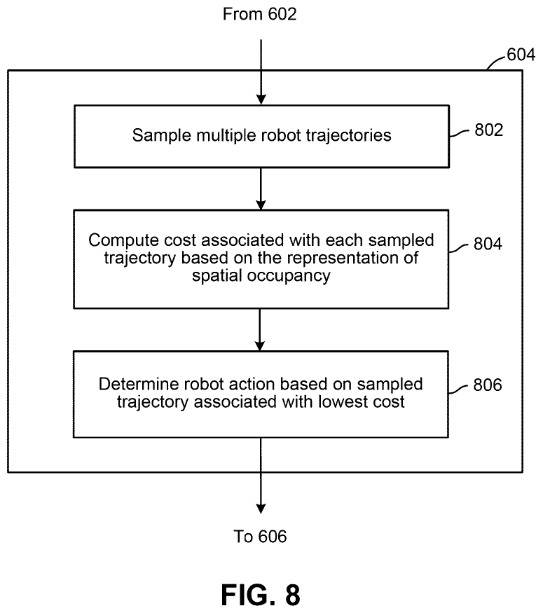

At step 606, the robot control application 116 determines a robot action based on a goal and the representation of spatial occupancy generated at step 604. In some embodiments, the robot control application 116 performs a model predictive control technique, which can be accelerated via a GPU, by determining the robot action by sampling multiple robot trajectories, computing a cost associated with each sampled trajectory based on the representational of spatial occupancy, and determining a robot action based on one of the sampled trajectories that is associated with a lowest cost, as described in greater detail below in conjunction with FIG. 8.

At step 608, the robot control application 116 controls a robot to perform at least a portion of a movement based on the robot action determined at step 606. For example, the robot controller 116 could transmit one or more signals to a controller of joints of the robot, thereby causing the robot to move so as to achieve the robot action.

At step 610, the robot control application 116 determines whether to continue iterating. In some embodiments, the robot control application 116 continues iterating if the goal has not been achieved. If the robot control application 116 determines to step iterating, then the method 600 ends. On the other hand, if the robot control application 116 determines to continue iterating, then the method 600 returns to step 606, where the robot control application 116 determines another robot action based on the goal and the representation of spatial occupancy.

FIG. 7 is a more detailed illustration of the step 604 of generating a representation of spatial occupancy based on RGB images set forth in FIG. 6, according to various embodiments. Although the method steps are described in conjunction with the systems of FIGS. 1-3, persons skilled in the art will understand that any system configured to perform the method steps in any order falls within the scope of the present embodiments.

As shown, at step 702, the occupancy representation regenerator 116 determines camera poses associated with the RGB images received at step 602. In some embodiments, the camera poses can be determined in any technically feasible manner, such as using forward kinematics when the RGB images are captured by a camera mounted on a robot, by applying a SfM technique to the RGB images, by requesting the camera poses from an augmented reality toolkit that provides such camera poses, etc., as described above in conjunction with FIG. 3.

At step 704, the occupancy representation regenerator 116 trains a NeRF model based on the RGB images and the associated camera poses. In some embodiments, training the NeRF model includes initializing weights of the NeRF model to random values and updating the weight values over a number of training iterations to minimize a loss function, using as training data the RGB images and the associated camera poses.

At step 706, the occupancy representation regenerator 116 generates a 3D mesh based on querying of the NeRF model. As described, the NeRF model can be queried to determine whether points in space are occupied based on associated densities output by the NeRF model. In some embodiments, points that are associated with densities that are greater than a threshold are considered occupied, and the 3D mesh is constructed from such points. For example, in some embodiments, a Marching Cubes technique can be performed to extract a polynomial mesh of an isosurface from a 3D discrete density field obtained by querying the NeRF model on a dense grid of point locations, as described above in conjunction with FIGS. 3-4.

At step 708, the occupancy representation regenerator 116 generates an ESDF based on the 3D mesh. The ESDF can be generated by computing the distances from various points in space (e.g., points on a grid) to the 3D mesh, which become values of the ESDF.

FIG. 8 is a more detailed illustration of the step 606 of determining a robot action based on a goal and a representation of spatial occupancy set forth in FIG. 6, according to various embodiments. Although the method steps are described in conjunction with the systems of FIGS. 1-3, persons skilled in the art will understand that any system configured to perform the method steps in any order falls within the scope of the present embodiments.

As shown, at step 802, the robot control application 116 samples multiple robot trajectories. For example, 500 trajectories could be sampled by the robot control application 116. In some embodiments, each sampled trajectory includes a randomly generated sequence of actions, such as joint-space accelerations, of the robot that extends a fixed number of time steps into the future.

At step 804, the robot control application 116 computes costs associated with each sampled trajectory based on the representation of occupancy. In some embodiments, the cost function includes a term that penalizes collisions of the robot with objects in the environment when the robot moves according to a sampled trajectory, with the collisions being determined using the representation of occupancy, as described above in conjunction with FIGS. 3 and 5.

At step 806, the robot control application 116 determines a robot action based on the sampled trajectory associated with a lowest cost. For example, in some embodiments, the robot action can be a first joint-space acceleration in the sampled trajectory associated with the lowest cost.

In sum, techniques are disclosed for controlling a robot within an environment. In the disclosed techniques, a representation of spatial occupancy within the environment is generated based on RGB images of the environment. In some embodiments, the representation of spatial occupancy is an ESDF that is generated by determining camera poses associated with the RGB images, training a NeRF model based on the RGB images and the associated camera poses, generating a 3D mesh by querying the NeRF model, and converting the 3D mesh to the ESDF. After the ESDF is generated, a robot control application can control a robot within the environment to avoid obstacles, by iteratively: determining a robot action based on a goal and the ESDF, and controlling the robot to move based on the robot action.

At least one technical advantage of the disclosed techniques relative to the prior art is that, with the disclosed techniques, RGB images, rather than depth data, are used to create a representation of spatial occupancy within an environment used to control a robot. The RGB images can be more accurate, and can have higher resolution, than depth data that is acquired via a depth camera. By using the RGB images, relatively accurate representations of spatial occupancy can be created and used to control robots within various environments. These technical advantages represent one or more technological improvements over prior art approaches.

1. In some embodiments, a computer-implemented method for controlling a robot comprises generating a representation of spatial occupancy within an environment based on a plurality of red, green, blue (RGB) images of the environment, determining one or more actions for the robot based on the representation of spatial occupancy and a goal, and causing the robot to perform at least a portion of a movement based on the one or more actions.

2. The computer-implemented method of clause 1, wherein generating the representation of spatial occupancy comprises determining a plurality of camera poses associated with the plurality of RGB images, training a neural radiance field (NeRF) model based on the plurality of RGB images and the plurality of camera poses, generating a three-dimensional (3D) mesh based on the NeRF model, and computing a signed distance function based on the 3D mesh.

3. The computer-implemented method of clauses 1 or 2, wherein determining the plurality of camera poses comprises performing one or more forward kinematics operations based on joint parameters associated with the robot when the plurality of RGB images were captured.

4. The computer-implemented method of any of clauses 1-3, wherein determining the plurality of camera poses comprises performing one or more structure-from-motion operations based on the plurality of RGB images.

5. The computer-implemented method of any of clauses 1-4, wherein the representation of spatial occupancy comprises at least one of a signed distance function, a voxel representation of occupancy, or a point cloud.

6. The computer-implemented method of any of clauses 1-5, wherein determining the one or more actions for the robot comprises, for each of one or more iterations sampling a plurality of trajectories of the robot, computing a cost associated with each trajectory based on the representation of spatial occupancy, and determining an action for the robot based on a first trajectory included in the plurality of trajectories that is associated with a lowest cost.

7. The computer-implemented method of any of clauses 1-6, wherein computing the cost associated with each trajectory comprises determining, based on the representation of spatial occupancy, whether one or more spheres bounding one or more links of the robot collide or intersect with one or more objects in the environment.

8. The computer-implemented method of any of clauses 1-7, wherein the cost associated with each trajectory is computed based on a cost function that penalizes collisions between the robot and one or more objects in the environment when the robot moves according to the trajectory.

9. The computer-implemented method of any of clauses 1-8, further comprising capturing the plurality of RGB images via a camera mounted on the robot.

10. The computer-implemented method of any of clauses 1-9, further comprising capturing the plurality of RGB images via a camera that is moved across a portion of the environment.

11. In some embodiments, one or more non-transitory computer-readable media storing instructions that, when executed by at least one processor, cause the at least one processor to perform the steps of generating a representation of spatial occupancy within an environment based on a plurality of red, green, blue (RGB) images of the environment, determining one or more actions for a robot based on the representation of spatial occupancy and a goal, and causing the robot to perform at least a portion of a movement based on the one or more actions.

12. The one or more non-transitory computer-readable media of clause 11, wherein generating the representation of spatial occupancy comprises determining a plurality of camera poses associated with the plurality of RGB images, training a neural radiance field (NeRF) model based on the plurality of RGB images and the plurality of camera poses, generating a three-dimensional (3D) mesh based on the NeRF model, and computing a signed distance function based on the 3D mesh.

13. The one or more non-transitory computer-readable media of clauses 11 or 12, wherein determining the plurality of camera poses comprises performing one or more forward kinematics operations based on joint parameters associated with the robot when the plurality of RGB images were captured.

14. The one or more non-transitory computer-readable media of any of clauses 11-13, wherein determining the plurality of camera poses comprises performing one or more structure-from-motion operations based on the plurality of RGB images.

15. The one or more non-transitory computer-readable media of any of clauses 11-14, wherein the representation of spatial occupancy comprises at least one of a signed distance function, a voxel representation of occupancy, or a point cloud.

16. The one or more non-transitory computer-readable media of any of clauses 11-15, wherein determining the one or more actions for the robot comprises, for each of one or more iterations sampling a plurality of trajectories of the robot, computing a cost associated with each trajectory based on the representation of spatial occupancy, and determining an action for the robot based on a first trajectory included in the plurality of trajectories that is associated with a lowest cost.

17. The one or more non-transitory computer-readable media of any of clauses 11-16, wherein the cost is further computed based on a goal for the robot to achieve.

18. The one or more non-transitory computer-readable media of any of clauses 11-17, wherein the instructions, when executed by the at least one processor, further cause the at least one processor to perform the steps of causing the plurality of RGB images to be captured via a camera that at least one of is mounted on the robot or is moved across a portion of the environment.

19. The one or more non-transitory computer-readable media of any of clauses 11-18, wherein the instructions, when executed by the at least one processor, further cause the at least one processor to perform the steps of generating a three-dimensional (3D) reconstruction of the environment based on the plurality of RGB images, and generating depth data based on the 3D reconstruction of the environment, wherein the representation of spatial occupancy is further generated based on the depth data.

20. In some embodiments, a system comprises a robot, and a computing system that comprises one or more memories storing instructions, and one or more processors that are coupled to the one or more memories and, when executing the instructions, are configured to generate a representation of spatial occupancy within an environment based on a plurality of red, green, blue (RGB) images of the environment, determine one or more actions for the robot based on the representation of spatial occupancy and a goal, and cause the robot to perform at least a portion of a movement based on the one or more actions.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for controlling a robot, the method comprising:
generating a representation of spatial occupancy within an environment based on a plurality of red, green, blue (RGB) images of the environment;
determining one or more actions for the robot based on the representation of spatial occupancy and a goal; and
causing the robot to perform at least a portion of a movement based on the one or more actions.

2. The computer-implemented method of claim 1, wherein generating the representation of spatial occupancy comprises:
determining a plurality of camera poses associated with the plurality of RGB images;
training a neural radiance field (NeRF) model based on the plurality of RGB images and the plurality of camera poses;
generating a three-dimensional (3D) mesh based on the NeRF model; and
computing a signed distance function based on the 3D mesh.

3. The computer-implemented method of claim 2, wherein determining the plurality of camera poses comprises performing one or more forward kinematics operations based on joint parameters associated with the robot when the plurality of RGB images were captured.

4. The computer-implemented method of claim 2, wherein determining the plurality of camera poses comprises performing one or more structure-from-motion operations based on the plurality of RGB images.

5. The computer-implemented method of claim 1, wherein the representation of spatial occupancy comprises at least one of a signed distance function, a voxel representation of occupancy, or a point cloud.

6. The computer-implemented method of claim 1, wherein determining the one or more actions for the robot comprises, for each of one or more iterations:
sampling a plurality of trajectories of the robot;
computing a cost associated with each trajectory based on the representation of spatial occupancy; and
determining an action for the robot based on a first trajectory included in the plurality of trajectories that is associated with a lowest cost.

7. The computer-implemented method of claim 6, wherein computing the cost associated with each trajectory comprises determining, based on the representation of spatial occupancy, whether one or more spheres bounding one or more links of the robot collide or intersect with one or more objects in the environment.

8. The computer-implemented method of claim 6, wherein the cost associated with each trajectory is computed based on a cost function that penalizes collisions between the robot and one or more objects in the environment when the robot moves according to the trajectory.

9. The computer-implemented method of claim 1, further comprising capturing the plurality of RGB images via a camera mounted on the robot.

10. The computer-implemented method of claim 1, further comprising capturing the plurality of RGB images via a camera that is moved across a portion of the environment.

11. One or more non-transitory computer-readable media storing instructions that, when executed by at least one processor, cause the at least one processor to perform the steps of:
generating a representation of spatial occupancy within an environment based on a plurality of red, green, blue (RGB) images of the environment;
determining one or more actions for a robot based on the representation of spatial occupancy and a goal; and
causing the robot to perform at least a portion of a movement based on the one or more actions.

12. The one or more non-transitory computer-readable media of claim 11, wherein generating the representation of spatial occupancy comprises:
determining a plurality of camera poses associated with the plurality of RGB images;
training a neural radiance field (NeRF) model based on the plurality of RGB images and the plurality of camera poses;
generating a three-dimensional (3D) mesh based on the NeRF model; and
computing a signed distance function based on the 3D mesh.

13. The one or more non-transitory computer-readable media of claim 12, wherein determining the plurality of camera poses comprises performing one or more forward kinematics operations based on joint parameters associated with the robot when the plurality of RGB images were captured.

14. The one or more non-transitory computer-readable media of claim 12, wherein determining the plurality of camera poses comprises performing one or more structure-from-motion operations based on the plurality of RGB images.

15. The one or more non-transitory computer-readable media of claim 11, wherein the representation of spatial occupancy comprises at least one of a signed distance function, a voxel representation of occupancy, or a point cloud.

16. The one or more non-transitory computer-readable media of claim 11, wherein determining the one or more actions for the robot comprises, for each of one or more iterations:
sampling a plurality of trajectories of the robot;
computing a cost associated with each trajectory based on the representation of spatial occupancy; and
determining an action for the robot based on a first trajectory included in the plurality of trajectories that is associated with a lowest cost.

17. The one or more non-transitory computer-readable media of claim 16, wherein the cost is further computed based on a goal for the robot to achieve.

18. The one or more non-transitory computer-readable media of claim 11, wherein the instructions, when executed by the at least one processor, further cause the at least one processor to perform the steps of:
causing the plurality of RGB images to be captured via a camera that at least one of is mounted on the robot or is moved across a portion of the environment.

19. The one or more non-transitory computer-readable media of claim 11, wherein the instructions, when executed by the at least one processor, further cause the at least one processor to perform the steps of:
generating a three-dimensional (3D) reconstruction of the environment based on the plurality of RGB images; and
generating depth data based on the 3D reconstruction of the environment,
wherein the representation of spatial occupancy is further generated based on the depth data.

20. A system, comprising:
a robot; and
a computing system that comprises:
one or more memories storing instructions, and
one or more processors that are coupled to the one or more memories and, when executing the instructions, are configured to:
generate a representation of spatial occupancy within an environment based on a plurality of red, green, blue (RGB) images of the environment;
determine one or more actions for the robot based on the representation of spatial occupancy and a goal; and
cause the robot to perform at least a portion of a movement based on the one or more actions.
